(19) United States
(12) Patent Application Publication
(10) Pub. No.: US 2009/0084211 A1
(43) Pub. Date: Apr. 2, 2009

(54) HYPOID GEAR DEVICE AND FINAL REDUCTION GEAR FOR VEHICLE

(75) Inventors: Takayuki Aoyama, Aichi-ken (JP); Atsushi Suzuki, Aichi-ken (JP); Sho Honda, Aichi-ken (JP); Mizuho Inagaki, Aichi-ken (JP); Akifumi Miyazaki, Aichi-ken (JP); Yoshikatsu Shibata, Aichi-Ken (JP); Yasushi Hayashida, Aichi-ken (JP); Kazuhiko Yuasa, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignees: KABUSHIKI KAISHA TOYOTA CHUO KENKYUSHO, Aichi-gun (JP); TOYOTA JIDOSHA KABUSHIKI KAISHA, Toyota-shi (JP)

(21) Appl. No.: 11/912,707

(22) PCT Filed: May 24, 2006
(86) PCT No.: PCT/JP2006/310317

§ 371 Date: Oct. 26, 2007

(30) Foreign Application Priority Data
May 25, 2005 (JP) 2005-152300

(51) Int. Cl. F16H 1/14

(52) U.S. Cl. 74/424

(57) ABSTRACT

A hypoid gear device and a final reduction gear for a vehicle. The drive pinion (12) of the final reduction gear (10) having a hypoid gear is formed of a gear having a cylindrical outline. A drive pinion shaft (16) is projected from both sides of the drive pinion (12), and the drive pinion is supported on bearings (18) and (20) at these both projected portions. Since the outline of the drive pinion is formed in a cylindrical shape, the drive pinion can adopt a both side supporting structure. Thus, the deflection of the shaft can be suppressed and a bearing load can be lowered.

### TECHNICAL FIELD

The present invention relates to a support structure of a pinion which is one of the gears forming a hypoid gear device, and a final reduction gear for a vehicle which has a hypoid gear device.

### BACKGROUND ART

Front-engine, rear wheel drive vehicles, FR vehicles, in which an engine is mounted in the front portion of the vehicle and an output from the engine is transmitted to the rear wheels for driving typically have a final reduction gear for changing the direction in which to transmit the drive force from the engine by a right angle to distribute the force to the right and left driving wheels. The final reduction gear has a combined gear reducer having a hypoid gear device or a bevel gear for changing the transmission direction by a right angle, as described above, and a differential gear for allowing the right and left driving wheels to operate differently when the right and left wheels rotate in different speeds.

FIG. 3 shows a schematic structure of a conventional general final reduction gear 100. The combined gear reducer of the final reduction gear 100 is constructed in the form of a hypoid gear device formed including a pair of gears comprising a driving pinion 102 having a frustum outline and a ring gear 104 to be engaged with the drive pinion 102. The drive pinion 102 is supported in a cantilever manner, being mounted on one end of a drive pinion shaft 110 supported by two tapered roller bearings 106 and 108 arranged apart from each other. The drive pinion shaft 110 is connected via a flange companion 111 to a propeller shaft (not shown) which extends from a drive unit, including an engine, a transmission unit, or the like, and driven. The drive pinion 102 causes the ring gear 104 engaged therewith to rotate.

The ring gear 104 is connected to a differential gear. The differential gear comprises a differential case (hereinafter referred to as a “diff case”) 112 connected integral to the ring gear 104, a differential pinion shaft (hereinafter referred to as a diff pinion shaft) 114 connected to the diff case 112, two differential pinions (hereinafter referred to as diff pinions) 116 supported so as to rotate by the diff pinion shaft 114, two differential side gears (hereinafter referred to as diff side gears) 118 for engagement with the two respective diff pinions 116. Each of the diff side gears 118 receives the flange companion 120 connected thereto by means of a spline interface. A drive shaft is connected to each of the flange companions 120, so that the drive force is distributed and transmitted to the left and right driving wheels.

The drive pinion shaft 110 is supported by two bearings 106 and 108, as described above. A plastic spacer 126 is provided between the inner races 122 and 124 of these bearings 106 and 108. By screwing the nut 128 on the end of the drive pinion shaft 110 on the other side of the drive pinion 102, pressure force is applied to the plastic spacer 126 via the cylindrical portion of the flange companion 111 to thereby plastically deform the plastic spacer 126. As a result, the two inner races 122 and 124 are moved in a direction such that they approach closer to each other. Meanwhile, the outer races 130 and 132 of the bearings 106 and 108 are blocked by a differential carrier 134 from moving in the direction getting closer to each other. With this arrangement, predetermined preload is applied to the two bearings 106 and 108, and play in the axial direction can be removed. Also, an adjustment shim 136 is provided between the drive pinion 102 and the inner race 122 of the adjacent bearing 106. By adjusting the thickness of the adjustment shim 136, the axial position of the drive pinion 102 is adjusted.

Japanese Patent Laid-open Publication No. Hei 6-14727 describes one example of a vehicle final reduction gear.

Japanese Patent Laid-open Publication No. Hei 9-53702 and International Publication No. 01/65148 disclose a method for designing a gear surface of a hypoid gear device.

Supported in a cantilever manner, the drive pinion 102 of a conventional hypoid gear device suffers from a large deflection relative to the drive pinion shaft, and also a large bearing load.

Positioning and mounting of the drive pinion 102 in the axial direction requires adjustment of the thickness of the shim 136 while checking the tooth contact. As the tooth contact is affected by an error of even a few μm, the slightest error in machining the respective sections of the device may result in a serious problem. Therefore, as for an individual final reduction gear, the respective components, such as the drive pinion 102, the ring gear 104, and so forth, need to be assembled while checking the tooth contact and adjusting the shim. That is, a final reduction gear requires many man-hours in manufacturing.

Further, as preload is imparted to the bearing which supports the drive pinion shaft 110, larger rolling resistance of the bearing and lower load tolerance are resulted.

The present invention is advantageous in solving at least one of the above-described problems.

### SUMMARY OF THE INVENTION

A hypoid gear device according to the present invention has a pinion having a cylindrical outline and a ring gear for engagement with the pinion. The hypoid gear device according to the present invention further has a pinion shaft projecting on both sides of the pinion and bearings for supporting the pinion shaft on both sides of the pinion.

The gear surface of the pinion may be formed as an involute helicoid surface.

A format having a bearing to which no preload is applied can be employed.

The hypoid gear device having the above-described structure can be applied to a combined reduction gears having a hypoid gear device of a vehicle final reduction gear.

### BRIEF DESCRIPTION OF DRAWINGS

FIG. 1 is a cross sectional view showing a schematic structure of a vehicle final reduction gear according to an embodiment of the present invention;

FIG. 2 is a cross sectional view showing a schematic structure of a vehicle final reduction gear according to another embodiment; and

FIG. 3 is a cross sectional view showing a schematic structure of a conventional vehicle final reduction gear.

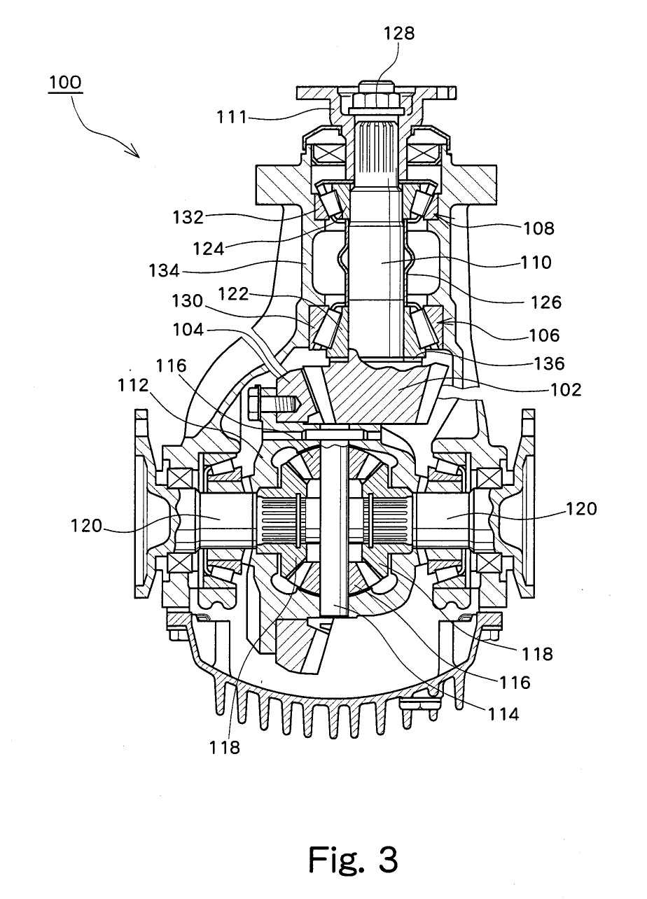

### DISCLOSURE OF INVENTION

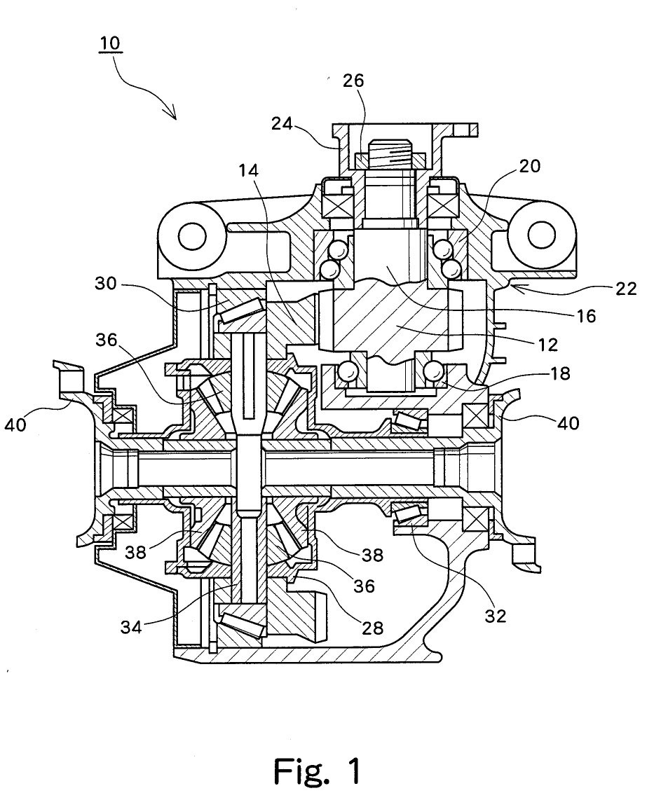

In the following, an embodiment of the present invention will be described with reference to the accompanying drawings. FIG. 1 is a cross sectional view schematically showing a vehicle final reduction gear 10 which employs a hypoid gear device in this embodiment. The vehicle final reduction gear 10 is mounted in an FR vehicle, and distributes the drive force transmitted from the engine via a propeller shaft (not shown) to the left and right rear wheels. In the transmission, the rotation of the propeller shaft is decelerated before being transmitted to the rear wheels. Further, should any difference in the rotation speeds of the left and right rear wheels result, differential operation is applied to absorb the difference.

A reduction gear device for realizing the deceleration function of the final reduction gear 10 is a hypoid gear device having a pair of gears comprising a drive pinion 12 and a ring gear 14. The drive pinion 12 has a cylindrical outline and is mounted on the drive pinion shaft 16. The drive pinion shaft 16 extends penetrating the drive pinion 12 from one side to the other (up and down directions in the drawing), and is supported so as to rotate on the diff carrier 2 on both adjacent sides thereof by the bearings 18 and 20. The drive pinion 12 is formed on, and integrally to, the drive pinion shaft 16. Specifically, a blank for formation of a drive pinion 12 is formed integral to the drive pinion shaft 16, and carved through cutting machining, or the like, such that a gear is resulted, whereby the drive pinion 12 and the drive pinion shaft 16 are formed integral to each other.

The bearings 18 and 20 are ball bearings, and no adjustment shim is provided for adjusting the axial position. The axial positions of the bearings 18 and 20 are determined depending on the accuracy in machining the surfaces of the diff carrier 22 and the drive pinion 12 which are brought into contact with the bearings 18 and 20. No preload is applied to the bearings 18 and 20. As shown in the drawing, in this embodiment, the lower bearing 18 shown in the drawing is a single-lined angular ball bearing, and the upper bearing 20 is a multiple-lined angular ball bearing. This formation, however, is not an exclusive example of the bearing formation, and any other formation which requires neither an adjustment shim nor preload application may be desirably employed in consideration of the use conditions. For example, a well base ball bearing and a cylindrical roller bearing are applicable.

On the upper end, in the drawing, of the drive pinion shaft 16, a flange companion 24 is connected by means of a nut 26, so that the drive pinion shaft 16 is connected to, and thereby driven by, the propeller shaft via the flange companion 24.

The ring gear 14, which has a gear surface conjugate with the gear surface of the drive pinion 12 and to be engaged with the drive pinion 12, is connected to the diff case 28 so as to be integral thereto, so that the integral ring gear 14 and diff case 28 are supported so as to rotate on the diff carrier 22 via two bearings 30 and 32. The diff case 28, a diff pinion shaft 34 fixed as penetrating through the diff case 28, a diff pinion 36 accommodated in the diff case 28, and a diff side gear 38 together constitute a differential gear which realizes the differential operation function of the final reduction gear 10. The diff pinion shaft 34 is positioned orthogonal to the rotational axis of the ring gear 14, having two diff pinions 36 supported thereon so as to rotate. Two diff side gears 38 are provided, respectively engaged with the two diff pinions 36 and so as to rotate around the axis orthogonal to the diff pinion shaft 34. Further, left and right flange companions 40 are connected to the diff side gear 38 by means of spline interface. These flange companions 24 are connected to the left and right drive shafts (not shown), transmitting the drive force to the left and right rear wheels.

The gear surfaces of the drive pinion 12 and ring gear 14 are formed based on the calculation according to a gear design method disclosed in Japanese Patent Laid-open Publication No. Hei 9-53702 and International Publication No. 01/65148, both described above. The drive pinion 12 is a cylindrical gear having an involute helicoid gear surface. The ring gear 14 has a gear surface conjugate with the gear surface of the drive pinion 12. As the drive pinion 12 is formed using a cylindrical gear and having an involute helicoid gear surface, slight displacement of the drive pinion 12 in the axial direction does not affect the tooth contact. That is, the regular state of engagement can be retained. Here, for a bevel gear having a frustum outline, axial displacement causes the distance between the engaged gears to change. Therefore, obviously, the regular state of engagement cannot be retained. For a cylindrical gear, on the other hand, axial displacement does not cause the distance between the gears to change. Moreover, as the involute helicoid gear surface is formed by moving in the axial direction the involute curve defined on one plane surface vertical to the rotational axis of a gear, while twisting at a predetermined helical angle, axial displacement of the gear does not hinder retention of the regular state of engagement. Obviously, displacement large enough to vary the width of the engagement between two mutually engaged gears results in change in the engagement rate as well as the tolerable load. Such a large displacement, however, can be sufficiently suppressed by adjusting the machining accuracy. Therefore, the hypoid gear device in this embodiment requires neither adjustment of the state of abutment using an adjustment shim nor highly accurate positioning of the drive pinion in the axial direction using pressure applied to the bearing. As a result, significantly fewer man-hours are required for manufacturing the final reduction gear.

When the pinion of the hypoid gear device is formed using a cylindrical gear having a cylindrical outline and an involute helicoid gear surface, advantageously, shim adjustment and application of preload to the bearing in positioning the pinion are unnecessary. This advantage is similarly obtained with a structure, such as a conventional final reduction gear, in which the bearing is supported in a cantilever manner as being mounted on one side of the pinion. That is, the above-described advantage can be obtained regardless of the support structure, that is, whether a both sides supporting structure or a cantilever supporting structure.

Therefore, it is possible to arrange the vehicle final reduction gear 10 such that the drive pinion 12 is supported in a cantilever manner by two bearings mounted closer to the drive shaft side (upper portion in the drawing) than the drive pinion 12.

Here, for a pinion in the form of a bevel gear, generally, a shaft cannot be provided on the tip end side of the bevel gear due to the need to ensure space for receiving the cutter for carving the gear surface. Meanwhile, for a pinion in the form of a cylindrical gear, as the cutter does not interfere, a shaft can be provided projecting on both sides of the pinion. This permits a both sides supporting structure. With a both sides supporting structure, a reduced load is applied to the bearing, compared to the cantilever support structure. This makes it possible to employ a bearing with a smaller tolerable load, that is, a smaller bearing. Consequently, the entirety of the hypoid gear device and the final reduction gear can be formed in a reduced size. Moreover, the both sides supporting structure can eliminate the need of projecting the pinion shaft largely on one side thereof. This also contributes to reduction in size of the device.

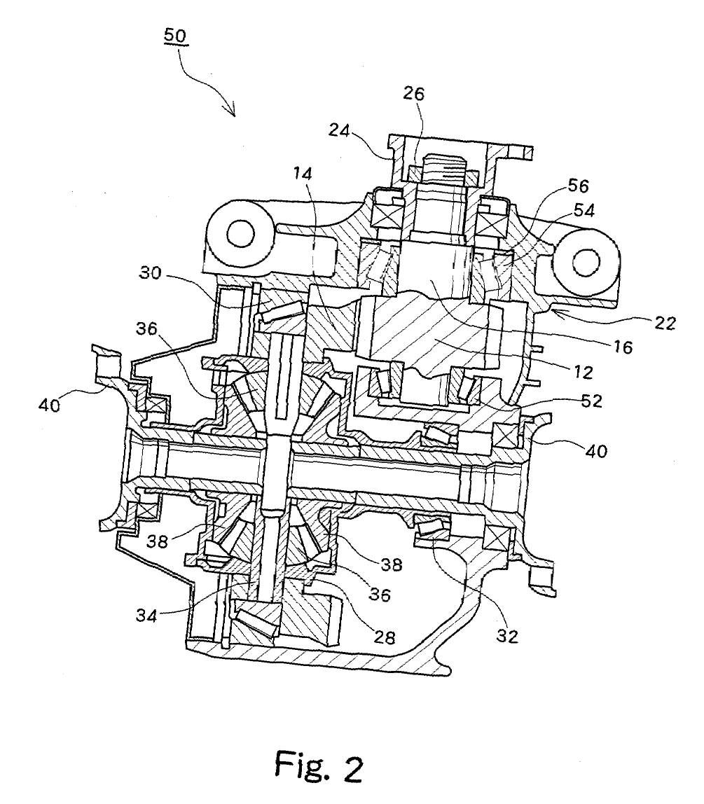

FIG. 2 is a cross sectional view schematically showing a vehicle final reduction gear 50 in another embodiment. This final reduction gear 50 differs from the above described final reduction gear 10 only in the structure of the bearing which supports the drive pinion 12. That is, whereas the bearings 18 and 20 of the final reduction gear 10 are ball bearings, the bearings 52 and 54 of the final reduction gear 50 are tapered roller bearings. In addition, an adjustment shim 56 is provided between the outer race of the bearing 54 on the propeller shaft side (the upper side in the drawing) and the diff carrier 22, and pressure is applied to remove the play in the axial direction. The structures other than those described above are identical to those of the final reduction gear 10 described above, with descriptions thereof not repeated here.

Because a pair of tapered roller bearings are employed, the final reduction gear 50 requires a step of adjustment using the adjustment shim 56 in assembling in order to apply predetermined pressure. However, as the axial position of the pinion does not affect the tooth contact, as described above, it is the pressure applied to the bearing that is adjusted in the adjustment step using the adjustment shim 56. Therefore, the shim adjustment step does not require determining the tooth contact and thus differs from the adjustment relevant to the drive pinion shaft of a convenient final reduction gear, with the result that fewer man-hours are required for this step.

The employment of a tapered roller bearing in the support structure of the drive pinion can increase the tolerable load of the ball bearing. That is, a small bearing can bear a larger load. This contributes to reduction in size of the hypoid gear device and the final reduction gear. Also, play of the drive pinion in the axial direction can be eliminated.

As described above, the drive pinion of each of the final reduction gears 10, 50 is formed using a cylindrical gear having an involute helicoid gear surface. With this arrangement, highly accurate positioning of the drive pinion in the axial direction is no longer necessary, and the number of components and man-hour required in manufacturing can be reduced. In particular, shim adjustment for attaining adequate state of abutment is no longer necessary. This particularly contributes to reducing the number of man-hours required for manufacturing.

Further, the drive pinion formed using a cylindrical gear can be supported in a center support manner. This arrangement enables reduction in size of the bearing and the device.

Still further, as larger tolerance for positioning of the drive pinion in the axial direction can be ensured, a certain amount of play in the axial direction can be permitted without effecting performance. This in turn makes it possible to employ a bearing, such as a ball bearing, to which no preload is applied. As a result, the man-hours required for managing components, such as shims, plastic spacers, and the like, or for making adjustments to the preload, and nut clamping torque, or the like, can be reduced.

Still further, resistance of the bearing caused due to pressure can be reduced. This can help increase efficiency in power transmission. Moreover, lubrication condition for the bearing is improved, which in turn enables reduction in size of the bearing itself and simplification of the oil groove for lubrication.

It should be noted that, although a final reduction gear for a vehicle, in particular an FR vehicle, has been described above, the present invention can be applied to any other device which employs a hypoid gear device.

What is claimed is:

1. A hypoid gear device, comprising:
a pinion having a cylindrical outline;
a ring gear having a gear surface conjugate with a gear surface of the pinion and engaged with the gear surface of the pinion;
a pinion shaft projecting on both sides of the pinion; and
bearings for supporting the pinion shaft on both sides of the pinion.

2. The hypoid gear device according to claim 1, wherein the gear surface of the pinion is an involute helicoid surface.

3. The hypoid gear device according to claim 2, wherein the bearings are each a rolling bearing to which no preload is applied.

4. The hypoid gear device according to claim 3, wherein the rolling bearing is a ball bearing.

5. The hypoid gear device according to claim 1, wherein the bearings are each a tapered roller bearing.

6. A vehicle final reduction gear having a hypoid gear device: comprising,
a drive pinion which is one of a pair of gears constituting the hypoid gear device, and having a cylindrical outline;
a ring gear which is another of the pair of gears constituting the hypoid gear device, and having a gear surface conjugate with a gear surface of the driven pinion;
a drive pinion shaft projecting on both sides of the pinion; and
bearings for supporting the pinion shaft on both sides of the drive pinion.

7. The vehicle final reduction gear according to claim 6, wherein the gear surface of the drive pinion is an involute helicoid surface.

8. The vehicle final reduction gear according to claim 7, wherein the bearings are each a rolling bearing to which no preload is applied.

9. The vehicle final reduction gear according to claim 8, wherein the rolling bearing is a ball bearing.

10. The vehicle final reduction gear according to claim 6, wherein the bearings are each a tapered roller bearing.
